(19) United States
(12) Patent Application Publication
(10) Pub. No.: US 2026/0035184 A1
(43) Pub. Date: Feb. 5, 2026

(54) SYSTEM FOR GENERATING AN OUTLIER INDICATION SIGNAL TO A SLAT CONVEYOR

(71) Applicant: SAIA-BURGESS LLC, VANDALIA, OH (US)

(72) Inventor: Adam STIENECKER, Tipp City, OH (US)

(21) Appl. No.: 19/351,921

(22) Filed: Oct. 7, 2025

Related U.S. Application Data
(63) Continuation of application No. PCT/US2023/018279, filed on Apr. 12, 2023.

(51) Int. Cl. B65G 43/02; B65G 17/06; B65G 47/82

(52) U.S. Cl. CPC B65G 43/02; B65G 47/82; B65G 17/067; B65G 2203/0266

(57) ABSTRACT

A system for generating an outlier indication signal to a slat conveyor is provided. The system includes a diverting assembly including an actuator that is structure do divert objects that are traveling on the slat conveyor. The system also includes at least one sensor and a controller that is connected to the sensor of the diverting assembly. The at least one sensor is positioned to detect a contact between the diverting assembly and at least one of a plurality of objects being conveyed. The controller is configured to receive first and second signals associated with first and second objects of the plurality of objects striking the diverting assembly, the control system also being configured to generate an outlier indication signal based on a time difference between the first and second signals.

### CROSS REFERENCE TO RELATED APPLICATIONS

This non-provisional patent application is a continuation application of PCT Application No. PCT/US2023/018279, filed with the USPTO on Apr. 12, 2023, which is incorporated herein by reference in its entirety.

### FIELD OF THE INVENTION

The present disclosure relates to a system for generating an outlier indication signal to a slat conveyor.

### BACKGROUND

In applications involving the sorting of objects within assembly or production lines, a diverting assembly can be used to divert objects on a slat conveyor in a direction that diverts from the direction of conveyor travel. These divert assemblies typically consist of a rotary solenoid attached to a divert finger that in one rotary angular position acts to have no influence on a passing object, and in a second rotary angular position acts to contact an object and to push the object from the conveyor into another means of object movement. Existing designs of diverting assemblies typically include a simple actuator assembly, and provide no information to the end user as to the proper functioning of the actuator and the slat conveyor system as a whole. As manufacturing capabilities become ever more complicated and sophisticated, the lack of feedback will put a limit on the potential operating efficiency of these systems.

The limit on this efficiency is in part, due to the inability of these systems to effectively predict system downtime due to a failure of one or more parts within the system.

It is therefore an object of the disclosure to provide a novel system that is capable of generating an outlier indication signal to a slat conveyor.

### SUMMARY OF THE INVENTION

According to an aspect, there is provided a system for generating an outlier indication signal to a slat conveyor, the slat conveyor including a transport member, the system comprising: a diverting assembly including: a diverting element, and an actuator that is operably connected to the diverting element for driving the diverting element between at least first and second positions relative to the transport member, at least one sensor positioned for detecting contact between each of a plurality of objects being conveyed and the diverting assembly; and at least one controller being operatively connected to the sensor, and being configured for: receiving a first signal from the at least one sensor in response to a first object of the plurality of objects contacting the diverting element, receiving a second signal from the at least one sensor in response to a second object of the plurality of objects contacting the diverting element, and determining whether to generate an outlier indication signal based on a time difference between the first signal and the second signal.

### BRIEF DESCRIPTION OF THE DRAWINGS

Embodiments will now be described, by way of example only, with reference to the attached Figures, wherein:

FIG. 1 shows a high-level architecture of the system in accordance with an embodiment of the disclosure and its operating environment;

FIG. 2A shows a side-view of a diagram of a slat conveyor according to an embodiment of the disclosure;

FIG. 2B shows a perspective view of an embodiment of the slat conveyor;

FIG. 3A shows a bottom view of the embodiment of the slat conveyor provided in FIG. 2B with the diverting element in the first position;

FIG. 3B shows a bottom view of the embodiment of the slat conveyor provided in FIG. 2B with the diverting element in the second position;

FIG. 3C shows a top view of the embodiment of the slat conveyor provided in FIG. 3A;

FIG. 4 shows a section view of the embodiment of the slat conveyor provided in FIG. 2B;

FIG. 5 shows a flow chart schematic of a method for generating an outlier indication signal to the slat conveyor, that is executed by the system in accordance with an embodiment of the disclosure;

FIG. 6 shows a flow chart schematic of an additional embodiment of the method provided in FIG. 5;

FIG. 7 shows a flow chart schematic of a further embodiment of the method provided in FIG. 5; and

FIG. 8 shows a flow chart schematic of an alternate embodiment of the method provided in FIG. 5.

### DETAILED DESCRIPTION OF THE PREFERRED EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The embodiments of the inventions described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

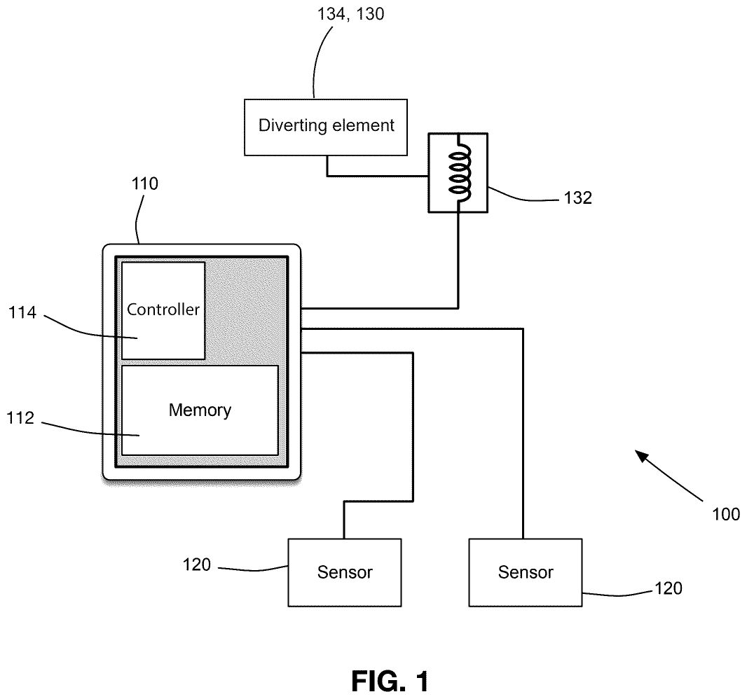

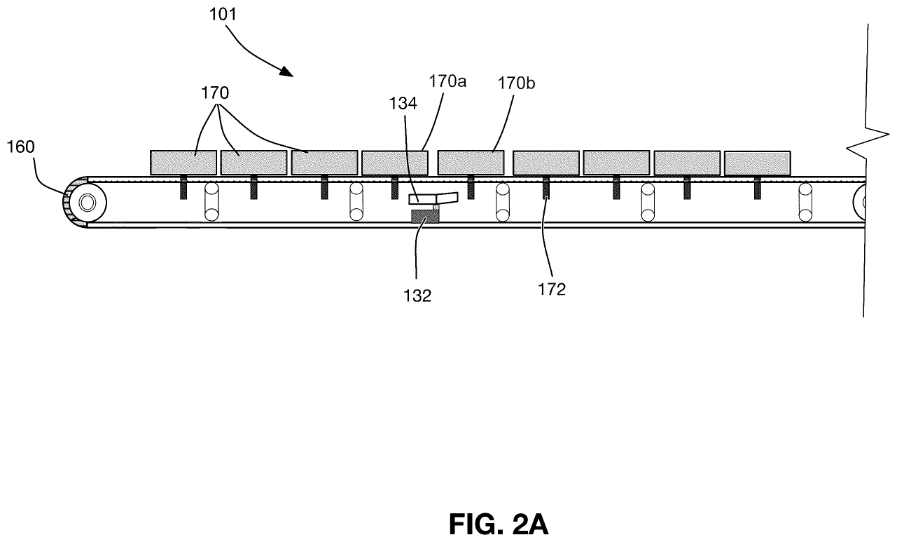

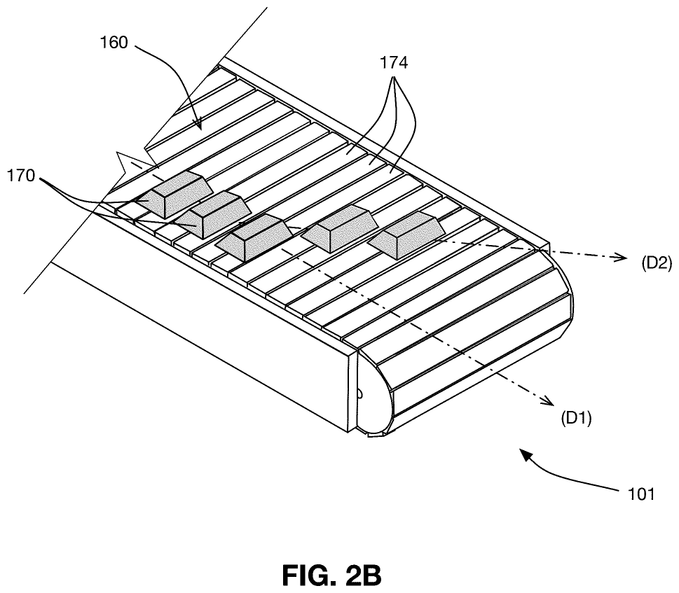

Referring to FIGS. 1, 2A, and 2B, there is provided an embodiment of a system 100 for generating an outlier indication signal to a slat conveyor 101, where the slat conveyor 101 includes a transport member 160, preferably an endless transport member, for conveying a plurality of objects 170. The transport member 160 includes a plurality of spaced-apart, transverse slats 174 for supporting the plurality of objects 170.

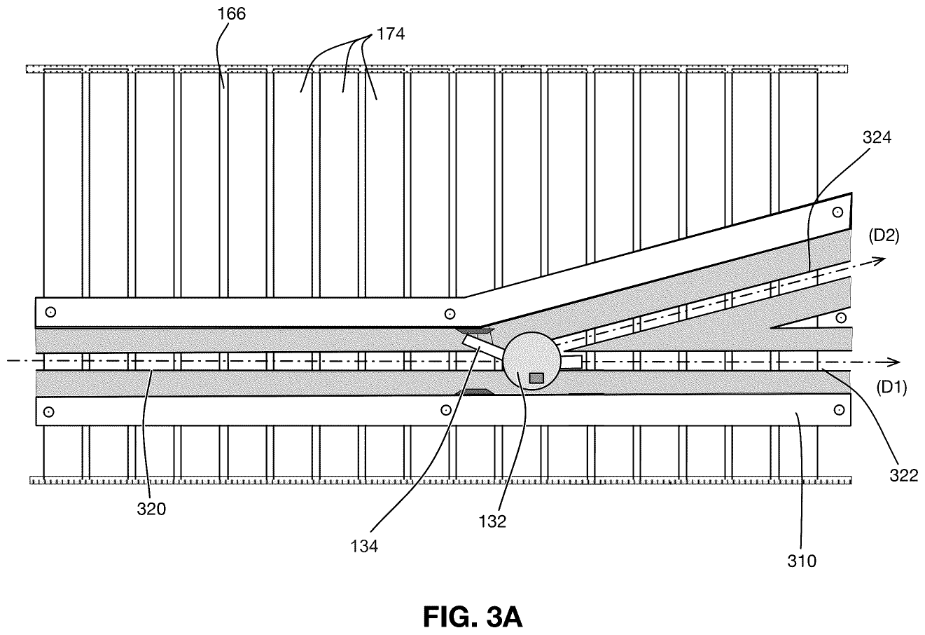

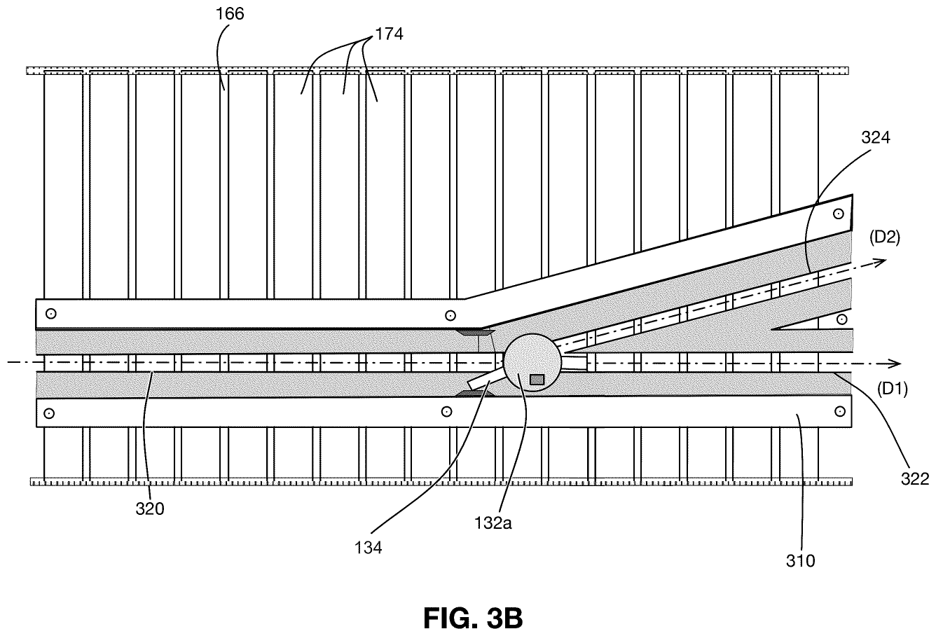

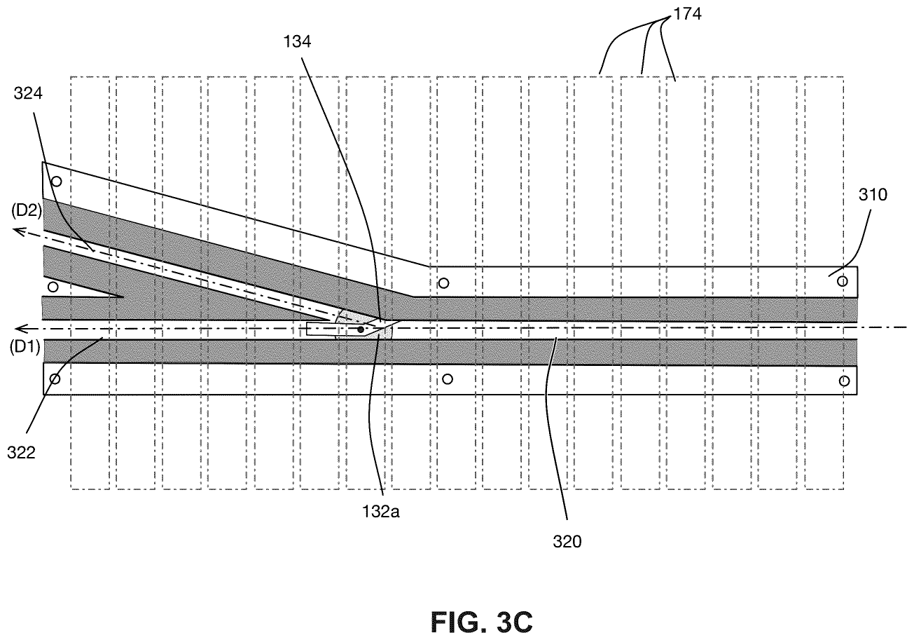

The system 100 includes a diverting assembly 130 that includes a diverting element 134, and an actuator 132 that is operably connected to the diverting element 134 for driving the diverting element 134 between at least a first position (See FIG. 3A) and a second position (See FIG. 3B) relative to the transport member 160. Preferably, the actuator 132 is a solenoid actuator 132a. Referring to FIGS. 3A and 3B, the solenoid actuator 132a is a rotary solenoid actuator. The diverting element 134 is connected to a driving shaft of the rotary solenoid actuator such that the first position of the diverting element 134 is a first rotational position and the second position of the diverting element 134 is a second rotational position.

Referring to FIGS. 3A to 3C, the slat conveyor 101 also includes a guide channel body 310 that defines guide channels 320 therewithin. The guide channels 320 include at least a main channel 322 and a secondary channel 324. The main channel 322 extends along the first direction (D1). The first direction (D1) is the direction along which each object of the plurality of objects 170 will travel if that specific object is not diverted by the diverting assembly 130. The secondary channel 324 extends along a second direction (D2). The second direction (D2) is the direction along which the objects of the plurality of objects 170 will travel if the objects 170 are diverted by the diverting assembly 130. The transport member 160 generally conveys the plurality of objects 170 along a first direction (D1) where a diverted subset of objects from the plurality of objects 170 are diverted from the first direction (D1) to the second direction (D2).

In an embodiment, the diverting element 134 of the diverting assembly 130 is movably mounted on the guide channel body 310 such that when diverting element 134 is driven to move between the first and second positions, the diverting element 134 moves relative to guide channels 320 of guide channel body 310.

In specific embodiment shown in FIGS. 3A and 3B, the diverting element 134 is a pivotably mounted relative to the guide channels 320, the first position of the diverting element 134 is a first angular position relative to the guide channels 320 and the second position of the diverting element 134 is a second angular position relative to the guide channels 320. The guide channels 320 and the diverting element 134 are located below the transport member 160. In an alternative embodiment, the guide channels 320 and the diverting element 134 can be located above the transport member 160.

In an alternate embodiment (not shown), the first direction relative to the slat conveyor 101 is a direction that projects away from a first side of the slat conveyor 101, at an angle relative to the longitudinal direction of the slat conveyor 101, and the second direction relative to the slat conveyor 101 is a direction that projects away from a second side of the slat conveyor 101 at an angle relative to the longitudinal direction of the slat conveyor 101. In this alternate embodiment, the diverting assembly 130 as disclosed herein is positioned within the slat conveyor 101 such that when the diverting element 134 of the diverting assembly 130 is in the second position, the diverting element 134 will redirect the at least one of the plurality of objects 170 on the slat conveyor 101 along the second direction relative to the longitudinal direction of the slat conveyor 101, and when the diverting element 134 is in the first position, the diverting element 134 will redirect the at least one of the plurality of objects 170 on the slat conveyor 101 along the first direction relative to the longitudinal direction of the slat conveyor 101.

In an embodiment, each consecutive pair of transverse slats 174 is formed to support one of the plurality of objects 170 therebetween.

In an additional embodiment, each object of plurality of objects 170 is removably secured in an identical, predetermined orientation along the transport member 160.

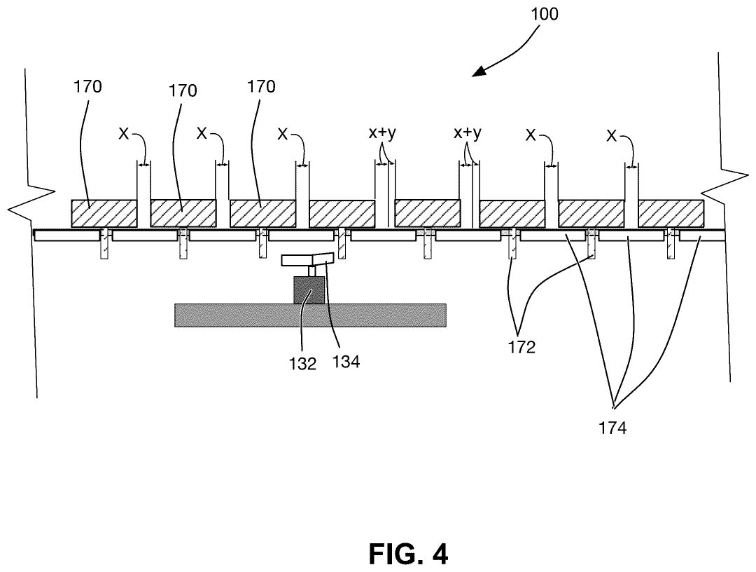

In an embodiment, each of the plurality of objects 170 includes a part that extends therefrom, where each of the parts extending from the plurality of objects 170 function as a contact member for contacting the diverting assembly 130. In this embodiment, each object of the plurality of objects 170 supported on each consecutive pair of transverse slats 174 (e.g., each sub-element of the transport member 160). The slats 174 are oriented such that the contact member of the object 170 at least partially extends into a gap 166 formed between each consecutive pair of transverse slats 174, so to contact the diverting assembly 130. In the specific embodiment provided in FIGS. 2A and 4, the contact member extends from each of the plurality of objects 170 are in the form of an elongated projection 172 (such as a pin).

In an alternate embodiment, the transport member 160 includes a plurality of object support elements for supporting the plurality of objects 170, wherein each of the plurality of object support elements includes a contact member for contacting the diverting assembly 130.

The system 100 further includes at least one sensor 120 that is positioned for detecting contact between each of the plurality of objects 170 and the diverting assembly 130. The system 100 also includes a control system 110 that is electrically connected to the sensor 120. Preferably, the control system 110 is further electrically connected to the actuator 132 to control the actuator 132. The control system 100 as disclosed herein includes at least one controller 114. The at least one controller 114 is configured for, in a first step S110, receiving a first signal from the at least one sensor 120 in response to a first object 170a of the plurality of objects contacting the diverting element 134, in a second step S120, receiving a second signal from the at least one sensor 120 in response to a second object 170b of the plurality of objects 170 contacting the diverting element 134, and in a third step S130, determining whether to generate an outlier indication signal based on a time difference between the first signal and the second signal. The time difference between the first signal and the second signal refers to a time interval between a first time point when the first signal is received and a second time point when the second signal is received.

When the slat conveyor 101 is assembled and first used, the slats are all arranged at an equal distance and thus the objects 170 are equally spaced on the transport member 160. Over time, the slat conveyor 101 may have stretched points (damaged points), causing the objects 170 to be unequally spaced.

For example, as shown in FIG. 4, the slat conveyor 101 includes two stretched points, where the distance “x+y” between two adjacent objects 170 at the stretched points is greater than a regular distance “x” between two adjacent objects 170. The increased distance “x+y” requires a longer conveying time.

In an embodiment, the outlier indication signal is generated on the basis that the time difference between the first signal and the second signal is outside of a threshold range. The threshold range is an acceptable range for time difference between the first signal and the second signal when the conveyor 101 runs normally. The threshold range can be determined when the slat conveyor 101 is first used.

The at least one controller 114 of the control system 110 can be at least one processor which can be in the form of a central-processing unit (“CPU”). The control system 110 may further include the memory 112 in electronic communication with the at least one controller 114, where the memory 112 has stored thereon the computer-executable instructions that are executable by the at least one controller 114.

In an embodiment, the at least one processor as disclosed herein is any processor or controller, and can be implemented as a singular processor or as a plurality of processors. In the embodiments where the at least one processor is the plurality of processors, the plurality of processors may be arrayed or distributed, and any processing function referred to herein may be carried out by one or by a plurality of the plurality of processors, even though a single processor may be exemplified.

In an embodiment, the memory 112 of the control system 110 as disclosed herein which stores the instructions for the at least one controller 114 includes computer readable media such as storage media, computer storage media, or data storage devices (removable and/or non-removable) such as, for example, magnetic disks, optical disks, or tape. The computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

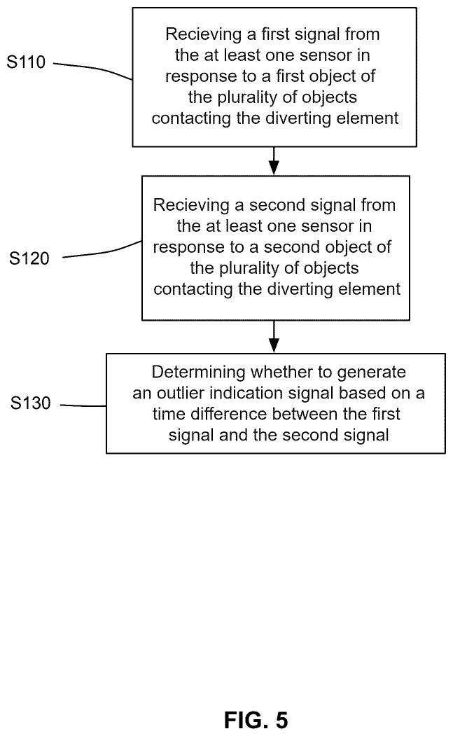

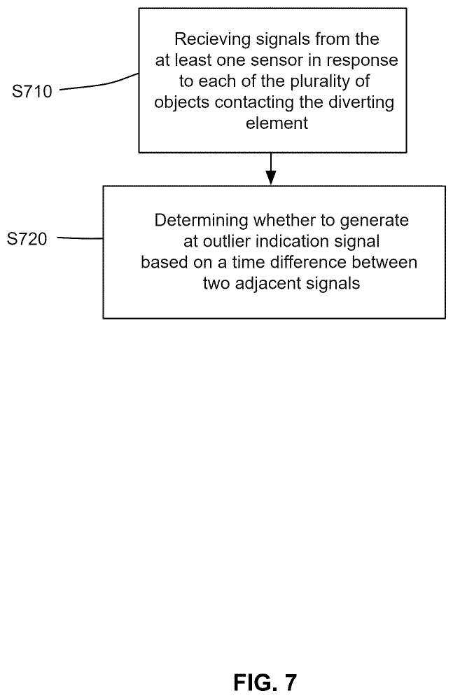

Referring to the embodiment provided in FIG. 7, the at least one controller 114 is configured for, in a first step S710, receiving signals from the at least one sensor 120 in response to each of the plurality of objects 170 contacting the diverting element 134, and in a second step S720, determining whether to generate an outlier indication signal based on a time difference between every two adjacent signals. That is, compared to the embodiment provided in FIG. 5, the at least one controller 114 of this embodiment is further configured for, receiving more signals from the at least one sensor 120 in response to other objects of the plurality of objects 170 contacting the diverting element 134, and determining whether to generate at least one subsequent outlier indication signal based on time differences between the signals received from the at least one sensor 120. The time differences between the signals refer to time intervals between time points of receiving the signals.

Ignoring the stretched points of the slat conveyor 101, the objects 170 to be diverted by the diverting element 134 can be substantially evenly arranged on the slats 174, as shown in FIGS. 2A and 4. As mentioned before, the increased distance “x+y” of the transport member 160 between adjacent objects 170 at the stretched points requires a longer conveying time, that is, a longer time difference will be incurred, so the at least one controller 114 generates the outlier indication signal or the at least one subsequent outlier indication signal under the condition that any of the time differences is outside of a threshold range, or there is an unacceptable change in the time difference between the adjacent signals.

The outlier indication signal generated by the controller 114 of the control system 110 functions to warn or otherwise indicate a failure, and/or a potentially failing aspect of the slat conveyor 101.

In an embodiment, the outlier indication signal may be indicative of stretched points of the transport member 160. For example, the sections of the transport member 160 between two adjacent objects 170 that requires a longer conveying time, i.e., a larger time difference, are the stretched points of the slat conveyor 101.

In an embodiment, the potentially failing aspect of the slat conveyor 101 is one of the diverting assembly contact members of the transport member 160, where the outlier indication signal is indicative of deformation of at least one of the diverting assembly contact members.

As noted above, the system 100 includes the at least one sensor 120 that is positioned for detecting contact between one of the plurality of objects 170 and the diverting assembly 130. In detecting a contact between one of the plurality of objects 170 and the diverting assembly 130, the at least sensor 120 produces at least one signal that is indicative of the contact between the one of the plurality of objects 170 and the diverting assembly 130. For example, the at least one sensor 130 produces a first signal in response to detecting the contact between the first object 170a of the plurality of objects 170 and the diverting assembly 130, and the at least one sensor 130 produces a second signal in response to detecting the contact between the second object 170b of the plurality of objects 170 and the diverting assembly 130.

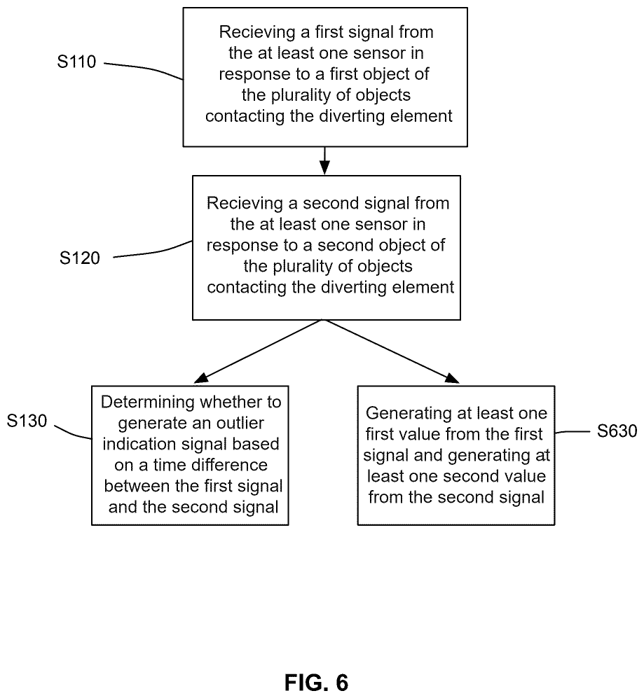

In an embodiment such as shown in FIG. 6, the at least one controller is configured for, in a step S630, generating at least one first value from the first signal, and generating at least one second value from the second signal. The first value generated from the first signal can be at least one first contact parameter that is associated with the first object 170a of the plurality of objects contacting the diverting element, and the second value generated from the second signal can be at least one second contact parameter that is associated with the second object 170b of the plurality of objects contacting the diverting element. The at least one controller may be further configured for generating an outlier indication signal under a condition that a difference between the first value and the second value is outside of a contact parameter threshold range.

In an embodiment, any contact between the diverting element 134 and an object of the plurality of objects 170 on the transport member 160 will apply a load on the driving element 134 itself. Depending on the magnitude and impulse of the load, varying degrees of the load will be translated to the diverting element 134, which can in turn translate into a vibratory motion of at least the diverting element 134 or the actuator 132 of the diverting assembly 130.

In an embodiment, the at least one sensor 120 is operably connected to one or more parts of the diverting assembly 130 to detect the load on the diverting assembly 130, or a vibratory motion of at least a part of the diverting assembly 130 due to the contact between the diverting element 134 and the object of the plurality of objects 170.

In an embodiment, the first value generated from the first signal is indicative of at least one of a maximum amplitude of a vibratory motion, a duration of a vibratory motion and a magnitude of a load associated with the first object 170a of the plurality of objects contacting the diverting assembly 130. In this same embodiment, the second value generated from the second signal includes at least one of a maximum amplitude of a vibratory motion, a duration of a vibratory motion and a magnitude of a load associated with the second object 170b of the plurality of objects contacting the diverting element.

In an embodiment, the at least one sensor 120 includes a load sensor that is positioned relative to the diverting element 134 and the actuator 132 to detect the load applied to the diverting assembly 130 due to the contact between the diverting element 134 and the one object of the plurality of objects 170. In an additional embodiment, the at least one sensor 120 includes a vibration sensor that is operably connected to the diverting element 134 and the actuator 132 to detect the vibrations applied to the diverting assembly 130 due to the contact between the diverting element 134 and the one object of the plurality of objects 170. The vibration sensor can be various known vibration sensors such accelerometers, displacement sensors and velocity sensors.

In yet another embodiment, the at least one sensor 120 includes at least one rotary position sensing means for detecting a rotatory position of the diverting element 134 of the diverting assembly 130.

In an embodiment, the at least one sensor 120 is mounted on the diverting element 134 of the diverting assembly 130 to detect a load associated with the diverting element 134 contacting an object of one of the plurality of objects 170, where the at least one signal generated by the at least one sensor 120 is associated with the load applied to the diverting element 134 of the diverting assembly. In this embodiment, the control system 110 determines at least one value from the at least one signal, where the at least one value is indicative of the load from the contact between the one object of the plurality of objects 170, and the diverting element 134.

In an alternate embodiment, the at least one sensor 120 is mounted on the actuator 132 of the diverting assembly 130 to detect a vibration of the actuator 132 associated with the diverting element 134 contacting an object of one of the plurality of objects 170. The at least one signal generated by the at least one sensor 120 is associated with the vibration of the actuator 132. In this embodiment, the control system 110 determines the at least one value from the at least one signal, where the at least one value is indicative of the vibration from the contact of the diverting assembly 130 due to the one object of the plurality of objects 170 contacting the diverting assembly 130.

Compared to the embodiment provided in FIG. 6, the at least one controller 114 of an additional embodiment is further configured for receiving more signals from the at least one sensor 120 in response to other objects of the plurality of objects 170 contacting the diverting element 134, generating more values from the signals. The at least one controller may be further configured for generating at least one subsequent outlier indication signal under a condition that a difference between adjacent values is outside of a contact parameter threshold.

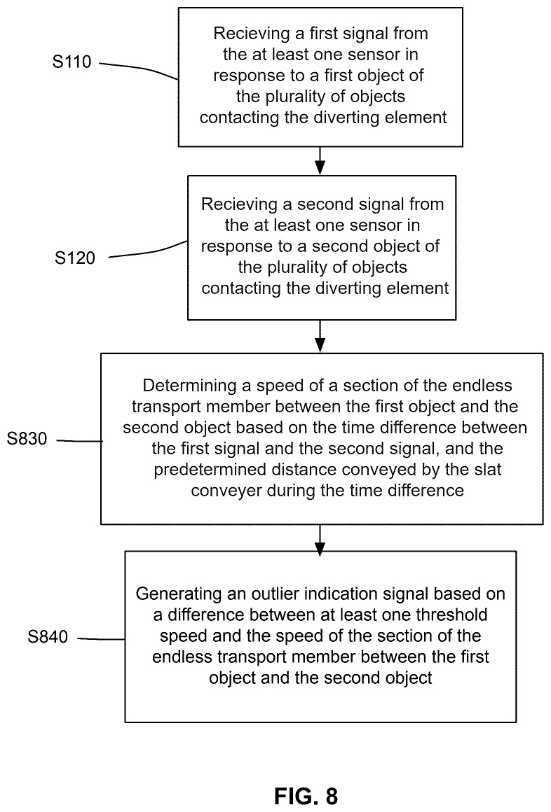

In some embodiments where a time difference between the first signal and the second signal, and a predetermined distance conveyed by the slat conveyor 101 during the time difference are utilized to estimate a speed of a section of the transport member 160 between the first object 170a and the second object 170b. Said another way, the controller is configured for performing the steps S110 and S120, and further performing the step S830 (see FIG. 8) of determining a speed of a section of the transport member 160 between the first object 170a and the second object 170b based on the time difference between the first signal and the second signal, and the predetermined distance conveyed by the slat conveyor during the time difference.

In specific embodiment shown in FIGS. 2A, 2B and 3A, the predetermined distance conveyed by the slat conveyor 101 during the time difference is the sum of the width of one slat 174 and the width of one gap 166. In alternative embodiments, the predetermined distance conveyed by the slat conveyor 101 depends on the number of the slats 174 between the first object 170a and the second object 170b.

In an embodiment, the speed of the section of the transport member 160 between the first object 170a and the second object 170b is compared to a threshold speed for the transport member 160 to determine if an outlier indication signal should be generated. As shown in FIG. 8, the controller is further configured for performing the step S840 where, based on the speed of the section of the transport member 160 between the first object 170a and the second object 170b (as determined in step S830), the outlier indication signal will be generated based on a difference between the threshold speed and the speed of the section of the transport member 160 between the first object 170a and the second object 170b.

In an embodiment, the outlier indication signal is indicative of an irregular speed of a section of the transport member 160. When the speed of the section of the transport member 160 between the first and second objects 170a and 170b is below the threshold speed, the controller outputs the outlier indication signal which is indicative of an irregular speed of the section of the transport member 160 due to wear, unevenness or stretching of the transport member 160.

Compared to the embodiment provided in FIG. 8, the at least one controller 114 of an alternative embodiment is configured for performing the steps S110, S120, S830, and further configured for receiving more signals from the at least one sensor 120 in response to other objects of the plurality of objects 170 contacting the diverting element 134, and determining the speeds of the sections of the transport member 160 between other adjacent objects 170, for example, including determining the speed of the section of the transport member 160 between the second object 170b and a third object 170 adjacent to the second object 170b. Ignoring the stretched points of the slat conveyor 101, the objects 170 to be diverted by the diverting element 134 can be substantially evenly arranged on the slats 174, as shown in FIGS. 2A and 4. The controller 114 may be further configured for generating at least one outlier indication signal under the condition that the speed of any sections is below the threshold speed, or there is an unacceptable change in the speed of the transport member.

In an embodiment, the controller is further configured for determining an average speed of the transport member 160. For example, the average speed can be calculated based on the speeds of all the sections of the transport member 160. The average speed also can be obtained by determining the speed of a section which spans the beginning and the end of the transport member 160. The memory 112 stores the average speed. The controller is further configured for updating the average speed of the transport member 160 once the average speed changes. In this embodiment, the aforementioned threshold speed can be determined according to the average speed.

In an additional embodiment of the control system 110, the at least one controller 114 is further configured for performing a step where, when the at least one sensor 120 detects the contact between the diverting assembly 130 and either of the first object 170a or the second object 170b of the plurality of objects 170, the control system 110 controls the actuator 132 to drive the diverting element 134 from either the first position to the second position, or from the second position to the first position. In an exemplary embodiment where the first position is a position of the diverting element 134 in which the diverting element 134 does not divert the one of the plurality of objects 170, the contact between the one of the plurality of objects 170 and the diverting assembly 130, when the diverting element 134 is in the second position, can function as a trigger to cause a “return” of the diverting element 134 to the first position.

The above-described embodiments are intended to be examples of the present disclosure and alterations and modifications may be effected thereto, by those of skill in the art, without departing from the scope of the disclosure that is defined solely by the claims appended hereto.

Part List

| | |
|---|---|
| system | 100 |
| slat conveyor | 101 |
| control system | 110 |
| memory | 112 |
| at least one controller | 114 |
| at least one sensor | 120 |
| diverting assembly | 130 |
| actuator | 132 |
| diverting element | 134 |
| transport member | 160 |
| longitudinal gap | 166 |
| plurality of objects | 170 |
| elongated projection | 172 |
| transverse slats | 174 |
| guide channel body | 310 |
| guide channels | 320 |
| main channel | 322 |
| secondary channel | 324 |

1. A system for generating an outlier indication signal to a slat conveyor, the slat conveyor including a transport member, the system comprising:
a diverting assembly including
a diverting element, and an actuator that is operably connected to the diverting element for driving the diverting element between at least first and second positions relative to the transport member;
at least one sensor positioned for detecting contact between each of a plurality of objects being conveyed and the diverting assembly; and
at least one controller being operatively connected to the sensor, and being configured for:
receiving a first signal from the at least one sensor in response to a first object of the plurality of objects contacting the diverting element;
receiving a second signal from the at least one sensor in response to a second object of the plurality of objects contacting the diverting element; and
determining whether to generate an outlier indication signal based on a time difference between the first signal and the second signal.

2. The system as claimed in claim 1, wherein, the at least one controller generates the outlier indication signal under the condition that the time difference is outside of a threshold range.

3. The system as claimed in claim 1, wherein, the transport member comprises a plurality of spaced-apart, transverse slats for supporting the plurality of objects, and each of the plurality of objects comprises a contact member which at least partially extends into a gap formed between each consecutive pair of transverse slats, so to contact the diverting assembly.

4. The system as claimed in claim 1, wherein, the at least one controller is further configured for:
receiving more signals from the at least one sensor in response to other objects of the plurality of objects contacting the diverting element, and
determining whether to generate at least one subsequent outlier indication signal based on time differences between the signals received from the at least one sensor,
wherein, the at least one controller generates the outlier indication signal or subsequent outlier indication signal under the condition that any of the time differences is outside of a threshold range, or there is an unacceptable change in the time difference between the adjacent signals.

5. The system as claimed in claim 1, wherein the controller is further configured for:
determining a speed of a section of the transport member between the first object and the second object based on the time difference between the first signal and the second signal, and a predetermined distance conveyed by the slat conveyor during the time difference.

6. The system as claimed in claim 5, wherein the outlier indication signal is generated under the condition that a threshold speed is larger than the speed of the section of the transport member between the first object and the second object.

7. The system as claimed in claim 1, wherein the controller is further configured for receiving more signals from the at least one sensor in response to other objects of the plurality of objects contacting the diverting element, and determining speeds of sections of the transport member between other adjacent objects.

8. The system as claimed in claim 7, wherein the controller is further configured for generating an outlier indication signal under the condition that the speed of any sections is the below threshold speed, or there is an unacceptable change in the speed of the transport member.

9. The system as claimed in claim 4, wherein the at least one controller is further configured for determining an average speed of the transport member.

10. The system as claimed in claim 9, wherein the at least one controller is further configured for updating the average speed of the transport member once the average speed changes.

11. The system as claimed in claim 1, wherein the actuator is a rotary solenoid actuator.

12. The system as claimed in claim 1, wherein the at least one controller is further configured for generating a first value from the first signal, and generating a second value from the second signal, and wherein the first value is indicative of a maximum amplitude of a vibration associated with the first object contacting the diverting assembly, and the second value is indicative of a maximum amplitude of a vibration associated with the second object contacting the diverting assembly.

13. The system as claimed in claim 1, wherein the at least one controller is further configured for generating a first value from the first signal, and generating a second value from the second signal, and wherein the first value is indicative of a magnitude of a load associated with the first object contacting the diverting assembly, and the second value is indicative of a magnitude of a load associated with the second object contacting the diverting assembly.

14. The system as claimed in claim 1, wherein the at least one controller is further configured for generating a first value from the first signal, and generating a second value from the second signal, and wherein the first value is indicative of a duration of a vibration associated with the first object contacting the diverting assembly, and the second value is indicative of a duration of a vibration associated with the second object contacting the diverting assembly.

15. The system as claimed in claim 12, wherein the at least one controller is further configured for generating an outlier indication signal under a condition that a difference between the first value and the second value is outside of a contact parameter threshold.
